(19) United States
(12) Patent Application Publication
(10) Pub. No.: US 2006/0112130 A1
(43) Pub. Date: May 25, 2006

(54) SYSTEM AND METHOD FOR RESOURCE MANAGEMENT

(76) Inventor: Linda Lowson, Huntington, NY (US)

Correspondence Address: LINDA M. LOWSON, 223 WALL STREET PMB 134, HUNTINGTON, NY, 11743, US

(21) Appl. No.: 11/164,477

(22) Filed: Nov. 23, 2005

Related U.S. Application Data
(60) Provisional application No. 60/630,774, filed on Nov. 24, 2004.

(51) Int. Cl. G06F 17/30

(52) U.S. Cl. 707/102

(57) ABSTRACT

A system and method that standardizes, automates, and facilitates the process of identifying, evaluating, selecting, and managing product and service resources for both individual and business resource users within specific industries. In one embodiment, this resource management system includes a web-based or other computer server with at least one database containing data related to product and service resources within a specific industry that can be searched and queried by the user, and at least one resource management system application that contains business rules and industry-specific or user-based criteria, qualitative and/or quantitative resource evaluation standards, and/or other guidelines or reference points, that, when applied to the product and service resource data, generates a resource-related selection, recommendation, rating, ranking, descriptive result, or other action or result that helps the user understand the resource options and the relative merits of the resource options for the user's particular needs, based in large part upon resource criteria chosen by the user, so that the user can make intelligent, informed, efficient, and timely decisions in sourcing, selecting, and managing these product and service resources. In this embodiment, the combination of unbiased industry-specific database information, unbiased industry-specific criteria and/or evaluation standards, and industry-specific search and querying capabilities, accessible on demand by the user, provides the user with a more accurate, precise, higher quality result that is reliable, immediately actionable, and can save the user time, money, and undesirable product or service performance results and/or customer service experiences. In another embodiment, this resource management system may further include software components that provide interactive communication and/or transactional capabilities for users and/or providers of the product and service resources, thus further facilitating the resource management process for both resource users and resource providers in a specific industry.

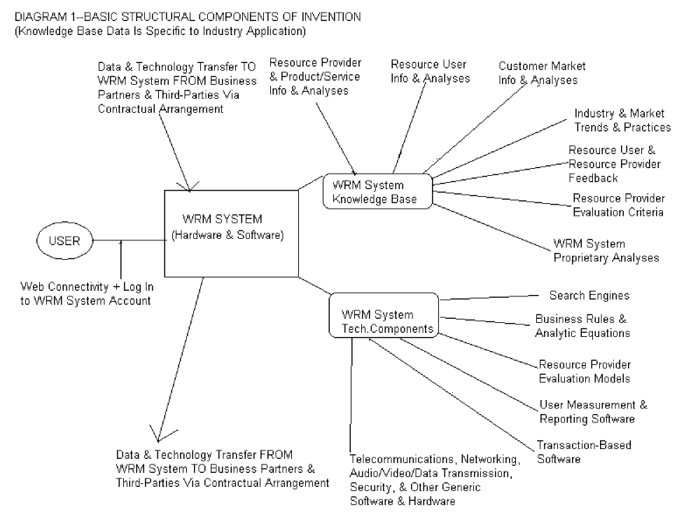

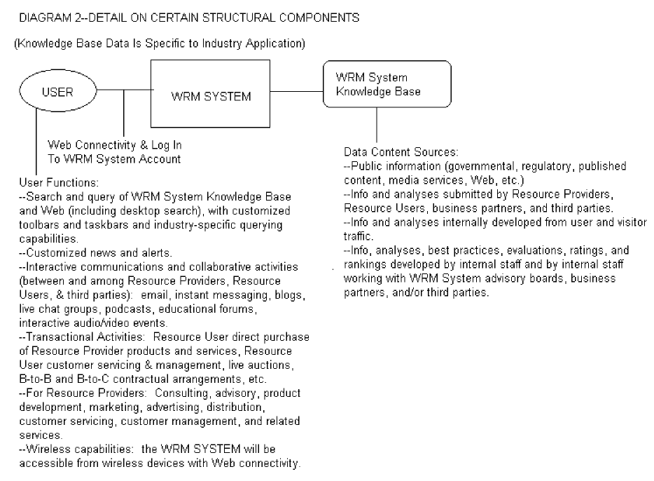

### CROSS-REFERENCE TO A RELATED APPLICATION

This application claims the benefit of U.S. Provisional Application No. 60/630,774, filed Nov, 24, 2004.

### FIELD OF THE INVENTION

This invention relates to the management of product and service resources, and more particularly, to an improved system and method for standardizing, automating, and facilitating the sourcing, evaluation, selection, management, and administration of product and service resources within specific industries and customer markets.

### BACKGROUND OF THE INVENTION

As demonstrated by the recent success enjoyed by companies that provide web-based search capabilities, both the individual and business consumer today continuously needs speedy, convenient, efficient access to product and service resources for a diverse and ever-changing range of personal and business needs. The quantity and specialization of product and service resources, together with the need and ability to access both global and local resources, have been increasing at a rapid rate, and will continue to increase for the foreseeable future. These market trends and market needs are driving the increasing need for a more sophisticated, standardized, automated, and customized tool for product and service resource sourcing, evaluation, selection, and management on an industry-specific basis.

The search results provided by current web-based search engines are based in large part upon a combination of computer algorithms, key word and metadata relevance, popularity of a web page (number of relevant visitors), behavioral click-stream information, advertiser conversion rates, price, and/or feedback from one's peers or other designated “community” (the latter is a recent phenomenon also referred to as “social intelligence”).

The “specialized” search engines that focus on specific industries or customer markets may provide product or service ratings or reviews based upon price and basic product or service characteristics, but in most cases any qualitative “evaluation” is based upon personal opinions of a narrowly defined web user population (social intelligence) and not upon industry-specific qualitative and/or quantitative evaluation standards, guidelines, or reference points in retrieving product or service search results.

Conceptually and technologically, this current search functionality (i) lacks proper industry-specific and/or user-based qualitative standards and guidelines in retrieving and ranking search results; (ii) lacks independent, standards-based evaluation of product and service resources for specific user needs; and (iii) as a result, in many if not most cases, provides the user with search results that are inaccurate, imprecise, unreliable, and/or useless in sourcing, evaluating, and selecting resources, and, further, provides no ability to ascertain whether the search results retrieved fulfill the user's requirements as to quality or other characteristics or attributes for the resources he is seeking.

Historically, before the advent of the Internet and web-based search engines, the critical process of sourcing, evaluating, and selecting product and service resources, by both business and individual resource users, was driven largely by word-of-mouth, media advertising, vendor marketing prowess, consultant bias, and reciprocal business arrangements. It was a process that was inefficient, haphazard, merely expedient, and governed by no clear-cut industry-specific guidelines or standards. This “process-deficient” resource management process still exists today as a prevalent market practice, supplemented by the “process-deficient” web-based search engine capabilities described above. More specifically, the ability to intelligently, efficiently, and economically manage product and service resources for industry-specific user needs through the use of a technology-based tool and/or information technology platform does not exist today.

This resource management process deficiency has been detrimental to both the resource user and the resource provider. For the resource user, it has resulted in (i) significant underutilization and imprecise use of available resource options; (ii) mediocre to substandard service performance and service quality from service providers; (iii) lack of best pricing; and (iv) an extremely fragmented, non-transparent marketplace within specific industries that prevents the resource user from gaining access to information that can improve his resource experience and performance results. For the resource provider, it has resulted in loss of market share and/or loss of pricing power by “best-of-breed” resource providers in favor of less-than-optimal resource providers for a given resource user need. This resource management process deficiency has prevailed for decades, despite the fact that the user's resource experience and actual performance results are based in large part upon the quality and other attributes, timeliness, and precision of the resources deployed.

An exemplary illustration of the detriment to resource users and resource providers caused by this resource management process deficiency can be found in the financial services industry. Individuals and businesses alike need to identify, select, and manage a broad range of financial services providers to help them manage their financial and non-financial assets. This fundamental market need has been growing in size and intensity as both the resource user and the resource provider marketplaces have continued to experience unprecedented growth over the last decade, driven by strong secular growth trends. At the same time, the financial services industry has developed widespread systemic problems, specifically, rampant conflicts of interest, self-dealing in fiduciary relationships, and similar shortcomings and ethical abuses by financial services providers, to the significant detriment of the financial services consumer. These abuses have prevailed because the consumer lacks the ability to efficiently and economically access accurate, comprehensive resource information and independent evaluations of these resources. The current sources of resource information consist of numerous, diverse, largely biased, and incomplete sources, including word-of-mouth, resource provider web sites, industry and news publications and information services, industry trade organizations, and media advertising. Examples of specific market practices resulting from this financial services resource management process deficiency are described below.

Many financial services providers are driven by a culture, mentality, and performance orientation based primarily upon one key metric: sales of their products and services (including accumulation of assets under management), since revenues and profits drive their bonuses and other compensation. The client's best interests are subordinated to this objective, and the client's needs are in many cases adapted to the financial services provider's compensation scheme.

Many individual consumers now rely primarily upon their friends and family (those they trust most) when selecting financial services providers. However, these sources generally base their resource recommendations almost solely upon personal experience and not upon objective market research or standards-driven evaluation. Thus, many high-quality financial services providers that should be evaluated by the resource user remain unknown to the resource user and/or are not considered in the resource selection process.

This financial services resource management process deficiency has negatively impacted both the financial services resource user and the financial services resource provider. For the resource user, the resource provider abuses described above have compromised the quality of the customer experience and the actual benefits (including pricing) and performance the customer has received. For the resource provider, a lack of trust by financial services consumers has caused a steady decrease in pricing power, brand strength, and customer loyalty. Thus, this invention presents a best-practice framework that is extremely timely in the current financial services environment—an environment besieged by conflicts of interest, lack of ethics, and lack of trust.

### SUMMARY OF THE INVENTION

This invention, hereinafter sometimes referred to as the “WRM SYSTEM”, is comprised of a web-based and/or computer-implemented system and method, with industry-specific system and method templates, for standardizing, automating, and facilitating, in whole or in part, the identification, evaluation, selection, management, and administration of product and service resources within specific industries and customer markets.

This system and method also may provide and facilitate, in whole or in part, consulting, advisory, product development, advertising, marketing, sales, distribution, customer servicing, customer management, and similar services for product and service resource providers within a specific industry.

This system and method also may provide and facilitate, in whole or in part, (i) interactive communications (including, for example, by email, instant messaging, VoIP, and other telecommunications technologies); (ii) collaborative activities (including, for example, blogs, live chat groups, podcasts, interactive forums, educational events, and social/cultural events); and (iii) transactional activities for users and providers of product and service resources within a specific industry, including, for example, direct purchase and fulfillment of product and service resources, live auctions of product and service resources, customer servicing, customer management, business-to-consumer contractual arrangements, and business-to-business contractual arrangements, between and among users and providers of product and service resources within a specific industry.

This invention is comprised of both functional technology components and database components. The functional technology components of this invention are comprised of one or more of the following components: (i) search engines that search and query the WRM SYSTEM databases and/or the Web; (ii) software components that combine business rules and/or analytic equations and/or industry-specific or user-based criteria, standards, or other relevant parameters or guidelines (including, for example and without limitation, the Resource Provider Evaluation Criteria and Resource Provider Evaluation Models described below), that, when applied to the WRM SYSTEM databases, generate a result or action that relates to the identification, evaluation, selection, management, and/or administration of product and service resources within a specific industry; (iii) user measurement and reporting software; (iv) transaction-based software; and (v) email, telecommunication, audio/video/data transmission, networking, security, and other conventional software and hardware.

The database components of this invention are comprised of one or more of the following components for a specific industry application of this invention: (i) information and analyses on specific product and service resources within specified business categories and/or user need categories within the specific industry; (ii) information and analyses on resource users within the specific industry; (iii) information and analyses on customer markets within the specific industry; (iv) information and analyses on trends, business practices, and/or market practices within the specific industry; (v) resource user and resource provider feedback within the specific industry; (vi) qualitative and/or quantitative resource evaluation standards, best practices, and/or evaluation models for the specific industry; and (vii) proprietary analyses of the foregoing database information, analyses, standards, and models, in whole or in part.

In one embodiment of this invention, resource users will be able to access on-demand, unbiased information and objective, standards-based, qualitative and quantitative evaluations, analyses, ratings, and recommendations, with respect to sourcing and selecting product and service resources within a specific industry for specific user needs, based upon user-based or user-defined criteria. In addition, users will be able to access on-demand guidance and education in formulating their search and other queries. Further, users will be able to query, communicate with, and transact business with, the providers of product and service resources within the specific industry. Resource providers will be able to receive customized, industry-specific and/or customer market-specific consulting, advisory, product development, advertising, marketing, sales, distribution, customer servicing, customer management, and similar services with respect to the products and services they provide to the resource users within the specific industry. Furthermore, resource users and resource providers within a specific industry will be able to interact informally and/or conduct business networking through sponsored social, cultural, educational, and similar events, online and offline.

This invention is designed for application to specific industries. With respect to the financial services industry application, as an exemplary embodiment of this invention, database information will include, for example, information and analyses on product and service resources with respect to the preservation, accumulation, transfer, divestiture, management, and administration of financial and non-financial assets by individuals and by businesses, including, for example, and without limitation, product and service resources for financial, investment, trading, brokerage, asset management, portfolio management, commercial banking, investment banking, custodial, philanthropic, business planning, management consulting, legal, tax, accounting, corporate finance, and transactional resource user needs.

This invention will provide concrete, practical benefits to both resource users and resource providers within a specific industry, including, for example, and without limitation, some or all of the following benefits: (i) Resource users will be able to save time and money in sourcing and evaluating resources; reduce or eliminate undesirable service experiences; receive better pricing and/or performance from resource providers; and have more confidence and trust in, and a more satisfying relationship with, service providers. (ii) Resource providers will receive 24/7 market exposure to customers and potential customers domestically and internationally through an independent, unbiased, high-quality information source, thus extending their market reach and building their brand within a receptive, targeted audience, at low cost. (iii) The industry-specific resource evaluation standards established by this invention, assuming this invention is used by an ever-growing audience, may encourage resource providers to maintain high standards in product and service quality, price, and performance, thus benefiting the industry as a whole. (iv) Resource users and resource providers within a specific industry will be able to interact informally and on a personal level, thus facilitating dialogue and meaningful and enjoyable relationships, which are important values in resource management and in our daily lives in general, and an increasingly sought-after experience in our society.

### DETAILED DESCRIPTION OF THE INVENTION

The detailed description set forth herein of exemplary embodiments of this invention makes reference to certain database and functional technology components, attributes, and processes, which show the exemplary embodiment by way of illustration and its best mode. While these exemplary embodiments are described in sufficient detail to enable those skilled in the art to practice this invention, it should be understood that other embodiments may be realized and that changes and modifications to these database and functional technology components, attributes, and processes may be made without departing from the spirit, scope, principles, and purposes of this invention.

Thus, the detailed description set forth herein of exemplary embodiments is presented for purposes of illustration only and not of limitation. For example, this invention contemplates various and distinct applications for specific industries as exemplary embodiments of this invention, and the database and functional technology components, attributes, and processes may vary in form and substance for each of these exemplary embodiments. Further, the steps recited in any of the method or process descriptions may be executed in any order and are not limited to the order presented. It should be appreciated that the particular embodiments described herein are illustrative of this invention and its best mode and are not intended to otherwise limit the scope or purposes of this invention in any way.

This invention may be described herein in terms of functional components, optional selections, and various processing steps. It should be appreciated that such functional components may be realized by any number of software and/or hardware components configured to perform the specified functions. Moreover, it should be noted that, for the sake of brevity, certain sub-components of this invention may not be described in detail herein, such as conventional data networking, application development, and other conventional technology aspects of this invention.

As will be appreciated by one of ordinary skill in the art, this invention may be embodied as a method, a data processing system, a device for data processing, and/or a computer program product. Accordingly, this invention may take the form of an entirely software embodiment, an entirely hardware embodiment, or an embodiment combining aspects of both software and hardware. Moreover, this invention may take the form of an Internet-based computer program accessible by any computer device, including wireless devices, which have connectivity to the Internet. Further, this invention may take the form of a computer program product on a computer-readable storage medium having computer-readable program code means embodied in the storage medium. Any suitable computer-readable storage medium may be utilized, for example, hard disks, CD-ROMs, DVDs, optical storage devices, magnetic storage devices, flash memory devices, or any type of media or device suitable for storing instructions and/or data.

The software components of this invention may be implemented with any programming or scripting language, such as C, C++, Java, COBOL, PERL, Visual Basic, SQL Stored Procedures, or extensible markup language (XML), with the various algorithms being implemented with any combination of data structures, objects, processes, routines or other programming elements. Further, it should be noted that this invention may employ any number of conventional techniques for data transmission, signaling, data processing, network control, and the like. In addition, the software components of this invention may include, without limitation, device drivers, operating systems, execution environments, and/or user applications.

All references herein to the “WRM SYSTEM” refer to this invention in whole or in part and are not meant to limit or define this invention in any way. This invention may be called or assigned other names, nomenclature, or classification, without affecting any component, attribute, process, principle, or purpose of this invention in any way.

A. WRM SYSTEM INFORMATION TECHNOLOGY PLATFORM: This invention, hereinafter sometimes referred to as the “WRM SYSTEM”, is comprised of a web-based and/or computer-implemented system and method, with industry-specific system and method templates, for standardizing, automating, and facilitating, in whole or in part, the identification, evaluation, selection, management, and administration of product and service resources within specific industries and customer markets. This system and method also may provide and facilitate, in whole or in part, consulting, advisory, product development, advertising, marketing, sales, distribution, customer servicing, customer management, and similar services for product and service resource providers within a specific industry. This system and method also may provide and facilitate, in whole or in part, interactive communications, collaborative activities, and transactional activities for users and providers of product and service resources within a specific industry, including, for example and without limitation, (i) email, instant messaging, blogs, live chats, VoIP (Voice over Internet Protocol), interactive forums, live audio/video events, wireless communications (such as those utilizing Bluetooth and/or Wi-Fi technologies), and other telecommunications capabilities; (ii) the direct purchase and fulfillment of product and service resources; (iii) live auctions of product and/or service resources; (iv) customer servicing and and customer management; and/or (v) contractual arrangements between and among users and providers of product and service resources within the specific industry.

This invention is comprised of both functional technology components and database components. The functional technology components of this invention are comprised of one or more of the following components: (i) search engines that search and query the WRM SYSTEM databases and/or the Web; (ii) software components that combine business rules and/or analytic equations and/or industry-specific or user-based criteria, standards, or other relevant parameters or guidelines (including, for example and without limitation, the Resource Provider Evaluation Criteria and Resource Provider Evaluation Models described below), that, when applied to the WRM SYSTEM databases, generate a result or action that relates to the identification, evaluation, selection, management, and/or administration of product and service resources within the specific industry; (iii) user measurement and reporting software; (iv) transaction-based software; and (v) email, telecommunication, audio/video/data transmission, networking, security, and other generic software and hardware.

The database components of this invention are comprised of one or more of the following components for a specific industry application of this invention: (i) information and analyses on specific product and service resources within specified business categories and/or user need categories within the specific industry; (ii) information and analyses on resource users within the specific industry; (iii) information and analyses on customer markets within the specific industry; (iii) information and analyses on trends, business practices, and/or market practices within the specific industry; (iv) resource user and resource provider feedback within the specific industry; (v) qualitative and/or quantitative resource evaluation standards, best practices, and/or evaluation models for the specific industry; and (vi) proprietary analyses of the foregoing database information, analyses, standards, and models, in whole or in part. These database information components are hereinafter sometimes collectively referred to as the “WRM Knowledge Base”.

A.1. ACCESS TO THE WRM SYSTEM: The WRM SYSTEM will be accessible via electronic networks and sites, computer application software, CD-ROMs, DVDs, and other suitable storage devices, remote access (mobile) software and hardware, and consulting and advisory services. Upon implementation, the WRM SYSTEM, and/or components thereof, will be located on the Internet at various web addresses, including, without limitation, http://www.wealthresourcemanagement.net, https://www.wrmconsult.net, and other web addresses (hereinafter sometimes collectively referred to as the “WRM Web Sites”). These web addresses are uniform resource locators (URLs) that can be entered into any supported web browser to access the web sites. The WRM SYSTEM will support the use of current versions of the most commonly used browsers, such as Microsoft's Internet Explorer. The “https” sites will be secured, protected sites, utilizing 128-bit encryption technology for any exchange of information from the web browser to the WRM SYSTEM, meaning that a user will be able to access the site, and particular functions or areas within the site, only with a permissible username and password and other authentication. The “https” sites will have a padlock icon in the bottom right status bar of the web browser. (More information about this certificate of security and the associated encryption technology will be available by clicking on the “Verisign Secure Site” icon on the bottom of the log-in screen.) The WRM SYSTEM, and/or components thereof, will be accessible from any computer location, assuming browser requirements have been met.

Users of this invention will have access to the WRM SYSTEM, and/or components thereof, in several ways, including, without limitation, in one or more of the following ways: (1) WRM Web Site Registration: certain WRM Web Sites, and/or portions thereof, will be accessible to the general public; registration and log in on the WRM Web Site home pages will be required to access the site; (2) WRM SYSTEM Electronic Subscription: certain WRM Web Sites, and/or portions thereof, will be accessible only by paid subscription; (3) WRM SYSTEM License: certain WRM SYSTEM functions will be accessible only by licensing certain data, technology, and/or application software; and/or (4) WRM SYSTEM Services: certain WRM SYSTEM functions will be accessible only by purchase of certain consulting, advisory, educational, product development, marketing, advertising, sales, distribution, customer servicing, customer management, or related services.

A.2. WRM SYSTEM DEVELOPMENT PROCESS: The WRM SYSTEM professional staff will develop and implement, and will work with business partners, independent contractors, and other third parties in developing and implementing, all WRM SYSTEM database components and functional technology components. In addition, certain database components and functional technology components have been developed in whole or in part, or will be developed in whole or in part, by third parties and will be incorporated into the WRM SYSTEM development process via license or other contractual arrangement. (Sections B, C, and D below provide further description of the development process for specific WRM SYSTEM components.)

B. WRM SYSTEM TECHNOLOGY COMPONENTS: B.1.SEARCH AND QUERY CAPABILITIES: The WRM SYSTEM will provide various search and query capabilities, including, without limitation, in one or more of the following ways:

The user will be able to perform search and query of the WRM SYSTEM Knowledge Base, or portions thereof, and/or of the Web. Search and querying functions will be performed via the WRM SYSTEM toolbars and querying taskbars, Web browser toolbars, and desktop toolbars. Toolbars and taskbars will have drop-down menus and will be customizable in settings and layout options. Examples of some of these toolbar and taskbar functions and menu options are described below in this section.

A user generally will be required to sign into his WRM SYSTEM account with proper credentials, permissions, and authentication in order to access WRM SYSTEM functions in whole or in part. Once logged in, the user will be able to select as his web home page the WRM SYSTEM home page on any WRM SYSTEM web site to which he has access, and will be able to personalize his home page content.

The WRM SYSTEM toolbars for Web search will support the most commonly used search engines, such as Google and Yahoo, and the most commonly used browsers, such as Microsoft Internet Explorer. Web search will simultaneously query multiple data sources via HTTP and XML, and will provide retrieval of search results from various types of data sources, such as third party search engines, meta search engines, RSS search engines, and RSS feeds from Web-based publishers and blogs.

The WRM SYSTEM Knowledge Base toolbars and taskbars will provide retrieval of search and query results from the WRM SYSTEM Knowledge Base or portions thereof. The user will be able to define, limit, and refine his search and queries by selecting various customized criteria and topical parameters. For example, with respect to the financial services industry application, as an exemplary embodiment of this invention, topical parameters may include, without limitation, resource user needs with respect to a given Resource Provider Category (see Section C below for a description of Resource Provider Categories). In addition, each Resource Provider Category may have a tools section with a customized search and querying taskbar containing menu options relevant to the Resource Provider Category. Querying of a Resource Provider Category also may provide the option to link directly to Resource Provider web sites, to link directly to the Resource Provider's products and services in the WRM SYSTEM marketplace sub-sites, and/or to conduct communications directly with Resource Providers via email and other communication capabilities, such as VoIP (Voice over Internet Protocol).

The WRM SYSTEM Desktop Search toolbars and taskbars will reside in Microsoft Windows and/or other commonly used operating systems, and will provide retrieval of search and query results from the WRM SYSTEM Knowledge Base or portions thereof and/or from the Web (after the user signs into his WRM SYSTEM account).

WRM SYSTEM search functions may have meta-utility functions, allowing simultaneous search of multiple Web-based search engines (including non-U.S.-based search engines) and of the WRM SYSTEM Knowledge Base. Search drivers, i.e., how search results are retrieved, may include, without limitation, one or more of the following drivers: key word/phrase metadata, boolean commands and operators, behavioral information and conversion rates shared by advertisers, the popularity of the web page within a given topic, user feedback, WRM SYSTEM proprietary algorithms and analytics, WRM SYSTEM Evaluation Models (described below in Section D), and WRM SYSTEM proprietary user data.

The user will be able to save searches, sort search results by designated criteria, and create and organize bookmarks for the Web or WRM SYSTEM results retrieved. In addition, the user may be able to import his bookmarks from the Internet Explorer toolbar and other browser search toolbars. Further, the user will be able to access an online research assistant and/or querying assistant. He may receive search suggestions as he types in search words and parameters, and will have access to his Search History. In addition, he may be able to use the WRM “wildcard” search operator by inserting an asterisk after a word or phrase.

The WRM SYSTEM toolbars and taskbars for WRM SYSTEM Resource Providers will enable the Resource Provider to request customized reports on user traffic, user activity, advertising click-through rates, and other user metrics, as well as various consulting, advisory, product development, marketing, sales, distribution, customer servicing, customer management, and related services.

The MyWRM toolbar (which may have other names or nomenclature) will provide additional features and functionality, including, without limitation, in one or more of the following ways: (1) This toolbar will be accessible from any WRM SYSTEM Web Site home page or search results page once the user logs into his WRM SYSTEM account. The toolbar will have a separate log in/log out (password protected and associated with the WRM SYSTEM ID to provide an additional level of security) and a separate search history. (2) This toolbar will allow the user to save and tag (annotate with descriptive keywords) retrieved search results to MyWRM and may allow him to share these tags with his designated “community” (including by email) and to browse the tags of his community. Tagging will allow pages to be saved by topic or other descriptive keywords (versus the traditional file folder structure of Web search), and the user will be able to annotate these tags. (3) The user will be able to view saved pages by clicking a tag, or combine tags to narrow his search and view all pages related to a group of tags. (4) The user may be able to block a link in any search result from appearing in subsequent searches, and manage his block history (add/delete blocked links). (5) The user may be able to send an invitation to his contacts to join his community, track the status of outstanding invitations, and manage his community (add/edit/delete community members and edit contact settings). In addition, the user may be able to import contacts from his Microsoft Outlook and other email programs.

B.2. CONTENT AND TECHNOLOGY DISTRIBUTION: The WRM SYSTEM will distribute and receive content and technology in several ways, including, for example and without limitation, in one or more of the following ways:

Content Distribution to WRM SYSTEM Users: The user will be able to retrieve WRM SYSTEM information by utilizing the WRM SYSTEM search and query toolbars and taskbars, as described in Section B.1 above. In addition, the user will be able to sign up to receive, via email notification and/or RSS feed, WRM SYSTEM news and alerts on industry-specific topics, Resource Provider categories, or other customized criteria. He will be able to select daily, weekly, or continuous (as they happen) notifications and feeds. In addition, WRM SYSTEM Resource Providers will be able to receive customized reports on user traffic, user activity, advertising click-through rates, and other user metrics, as well as information and analyses relating to product development, marketing, sales, distribution, customer servicing, customer management, and related areas.

Information Submission from WRM SYSTEM Resource Users: Resource Users will be able to submit various types of information and feedback to the WRM SYSTEM, including, for example and without limitation, in one or more of the following ways: (i) by filling out a Resource Provider customer review form or other type of feedback form on the WRM SYSTEM Web Sites; (ii) by participating in a Resource User customer satisfaction survey or other survey; (iii) by participating in a WRM SYSTEM Blog; and (iv) by attending a WRM SYSTEM online or offline event.

Information Submission from WRM SYSTEM Resource Providers: Resource Providers will be able to submit various types of information and feedback to the WRM SYSTEM, including, for example and without limitation, in one or more of the following ways: (i) by filling out a Resource Provider questionnaire form on the WRM SYSTEM Web Sites or submitting a printed copy of said form (said questionnaire will request information on the Resource Provider's business, products, services, customers, and related areas); (ii) by participating in a Resource Provider survey; (iii) by participating in a WRM SYSTEM Blog; and (iv) by attending a WRM SYSTEM online or offline event.

Content and Technology Distribution to and from Business Partners and Other Third Parties: WRM SYSTEM content may be distributed to WRM SYSTEM business partners and other third parties via license or other contractual arrangement, utilizing web hyperlinks, RSS feeds or other syndication format, advertising program options, and/or other content distribution options. In addition, WRM SYSTEM functional technology components, in whole or in part, may be licensed or transferred by contractual arrangement to business partners and other third parties. Furthermore, the WRM SYSTEM may incorporate content, software, or other technology components from business partners and other third parties, via license or other contractual arrangement.

B.3. INTERACTIVE COMMUNICATION AND COLLABORATIVE CAPABILITIES: The WRM SYSTEM will provide various types of interactive communication and collaborative capabilities, including, without limitation, in one or more of the following ways:

Blogs, Live Chat Groups, Podcasts, and Forums: The WRM SYSTEM Web Sites will host blogs, live chat groups, podcasts, and/or forums on a wide range of industry-specific topics and user needs. The WRM SYSTEM Web Sites also may provide links to “related” web blogs, chat groups, and podcasts. Further, users may be able to create their own blogs by using a WRM SYSTEM toolbar.

Email, Instant Messaging, and VoIP: Users will be able to send and receive email communications to and from WRM SYSTEM Web Sites, and to and from WRM SYSTEM Resource Providers via WRM SYSTEM links. In addition, a WRM SYSTEM web-based email program, with storage space, spam filters, and built-in WRM SYSTEM Search, as well as instant messaging capabilities, may be available to WRM SYSTEM Web Site registrants and users. Further, instant messaging and/or VoIP communications may be made available to registrants and users.

Interactive Audio/Video Web-Based Events: The WRM SYSTEM will host various types of educational conferences, seminars, and other events with interactive capabilities, including, for example and without limitation, the ability for the event attendee to submit questions to the event speakers.

Social and Cultural Events: The WRM SYSTEM will host various types of social, cultural, and business networking events to facilitate valuable and meaningful relationships among Resource Users and Resource Providers.

B.4. MARKETING AND ADVERTISING CAPABILITIES: The WRM SYSTEM will provide various types of marketing and advertising capabilities for WRM SYSTEM users, Resource Providers, and third parties, including, without limitation, in one or more of the following ways:

Web Advertising: Advertising options on the WRM SYSTEM Web Sites will include, for example and without limitation, one or more of the following: paid search, banner ads, pop up ads (which can be blocked by the site user), sponsored links (ad distribution to third-party sites with “related” content), and pay-per-performance ads. In addition, the viewer of the ad may be able to connect with the advertiser directly by clicking on a telephone link next to the ad.

Web Measurement Programs: The WRM SYSTEM will provide Resource Providers with various types of tools that will enable Resource Providers to test and refine their marketing, advertising, sales, and distribution campaigns, including, for example and without limitation, in one or more of the following ways: (i) customized analytic, measurement, and reporting tools that profile and measure visitor and user traffic with respect to the Resource Provider's WRM SYSTEM presence; and/or (ii) search and query toolbars and taskbars relating to marketing, advertising, sales, and distribution issues.

B.5. TRANSACTIONAL CAPABILITIES: The WRM SYSTEM will provide various types of transactional capabilities, including, for example and without limitation, in one or more of the following ways:

The WRM SYSTEM Web Sites may contain marketplace sub-sites that list Resource Provider product and service information and pricing, where Resource Provider products and services will be able to be purchased directly from the site, with credit card and PayPal payment options. These marketplace sites also will provide direct links to Resource Provider web sites and other related resources.

The WRM SYSTEM Web Sites may host live auctions and “Dutch” auctions relating to Resource Provider products and services and/or Resource User needs. Auction participants will be able to input and manage their bids directly on the site, and track auction activity.

The WRM SYSTEM Web Sites may contain sub-sites where Resource Providers can directly communicate with and transact business with WRM SYSTEM users in several ways, including, for example and without limitation, in one or more of the following ways: Resource Provider live interviews and other live audio and video events; customer service query and feedback forms; user input forms; and other relevant interchanges.

The WRM SYSTEM Web Sites may contain sub-sites where Resource Providers can directly communicate with and transact business with other WRM SYSTEM Resource Providers and third parties in several ways, including, for example and without limitation, in one or more of the following ways: online dialogue forums, input forms, and live hosted events for facilitating Resource Provider business partnering and collaboration; Resource Provider-sponsored interactive events; and other forums for Resource Provider-to-Resource Provider business transactions

B.6. WIRELESS CAPABILITIES: The WRM SYSTEM will provide various types of wireless capabilities, including, for example and without limitation, in one or more of the following ways: (i) the WRM SYSTEM Web Sites will be accessible from wireless devices that provide Web connectivity, and, once the user signs into his WRM SYSTEM account, he will be able to access some or all WRM SYSTEM functions from his wireless device, including, for example, search and query, news and alerts, RSS feeds, email programs, and other system capabilities; and (ii) the WRM SYSTEM application software may be downloadable onto wireless devices.

C. WRM SYSTEM KNOWLEDGE BASE: The WRM SYSTEM Knowledge Base will comprise the database components of the WRM SYSTEM, and is an essential element of this invention. An exemplary embodiment of the data content structure, data content sources, and data content compilation and system input process of this invention (hereinafter sometimes collectively referred to as the “Database Development Process”) is described below. The Database Development Process described below may be modified, amended, revised, and/or customized for specific industry applications of this invention, and said modifications, amendments, revisions, and/or customizations may be made without departing from the spirit, scope, principles, and purposes of this invention.

C.1. DATA CONTENT STRUCTURE: The WRM SYSTEM data content structure will contain certain categories of information and analyses relevant to Resource User and Resource Provider needs within a specific industry (hereinafter sometimes collectively referred to as the “Data Content Structure”). An exemplary embodiment of the Data Content Structure is set forth below for the application of this invention to the financial services industry.

C.1.a. Resource Provider Categories: WRM SYSTEM Resource Provider Categories will vary for each industry-specific application of this invention, and may be revised from time to time. With respect to the financial services industry application, as an exemplary embodiment of this invention, WRM SYSTEM Resource Provider Categories may contain some or all of the following categories, and may contain additional and/or revised categories as revised from time to time: (A) Financial Asset Management Resources: Alternative Investment Consulting, Alternative Investment Management, Audit and Assurance Services, Business Advisory Services, Business Publications and News Services, Business Software, Family Office Services, Family Wealth Planning, Financial Planning, Financial Publications and News Services, Financial Software, Industry Organizations, Insurance Brokerage and Consulting, Insurance Companies, Investment Banking, Investment Consulting, Investment Management, Investment Research, Legal Services (by Specialty), Lenders, Philanthropic Consulting, Philanthropic Organizations, Philanthropic Publications, Private Banking, Private Equity Firms, Securities Brokerage and Trading, Tax Planning and Compliance, Trust and Custody; (B) Non-Financial Asset Management Resources: Art, Antique, and Collectible Auction Firms; Art, Antique, and Collectible Consulting; Art, Antique, and Collectible Dealers and Galleries; Art, Antique, and Collectible Publications; and (C) Miscellaneous Resources: Travel Resources, Personal Shopping Resources, Cultural, Sports, and Entertainment Resources.

C.1.b. Categories of Resource Provider Information and Analyses: The categories of Resource Provider information and analyses will vary for each industry-specific application of this invention, and may be revised from time to time. With respect to the financial services industry application, as an exemplary embodiment of this invention, the categories of Resource Provider information and analyses may contain some or all of the categories listed below, and the elements within each category in whole or in part, and may contain additional and/or revised categories as revised from time to time (said categories of Resource Provider information and analyses are hereinafter sometimes collectively referred to as the “Resource Provider Evaluation Criteria”). The information and analyses compiled on these Resource Provider Evaluation Criteria for some or all Resource Providers will be regularly updated in whole or in part, and this updating process is an essential element of this invention.

Resource Provider Evaluation Criteria:

BUSINESS MODEL: Business Strategy, Product Strategy, Product Pricing, Client Composition, Innovation and Growth Strategy, Client Service Strategy, Competitive Strengths and Weaknesses, Business Risk, Brand and Reputation.

OPERATIONAL MODEL: Organizational Structure and Staffing, Standard Operating Procedures, Client Delivery Model, Management Strength (including Experience, Education, and Track Record), Performance Management Metrics (including Key Performance Indicators and Performance Incentives), Technology Strength (including Budget, Resource Allocation, and Utilization).

FINANCIAL METRICS: Client Market Size Growth Rate, Client Assets Under Management or Advisement Growth Rate, Annual Sales Growth, Annual Earnings Growth, Gross and Net Operating Margins, Debt/Equity Ratio, Capital Expenditures, Free Cash Flow, Return on Assets, Return on Equity, Financial Risk Management, Corporate Actions, Stock Ratings by Independent Third Parties, Debt Ratings by Independent Third Parties.

CORPORATE GOVERNANCE: Corporate Culture Strength and Quality (e.g., Conservative, Progressive, Aggressive, Innovative), Corporate Governance Policies and Procedures, Board Quality (including Experience, Education, and Track Record), Regulatory Issues (including Breach, Resolution, Remedies in Place, Scope of and Commitment to Reform), and Financial Controls (including Sarbanes-Oxley Compliance).

CUSTOMER SATISFACTION MEASUREMENT: Perceived Quality and Perceived Value, Price Tolerance, Product/Service Satisfaction, and Client Service Satisfaction.

BASIC BUSINESS DATA: Contact Information, Business Locations, Number of Employees, Type of Ownership, Market Capitalization, Business Description, Product/Service Description, Fields of Expertise, Number of Experts, Representative Client List, Representative Assignments, Number of Clients, Client Retention Rate, Amount of Assets Under Management or Advisement, Asset Management or Asset Advisement Performance, and Noteworthy News.

The number of Resource Provider Evaluation Criteria, and the nature and extent of the information and analyses within each Resource Provider Evaluation Criteria, for each Resource Provider will vary, depending upon (i) the Resource Provider's business category and business size; (ii) the availability of public and non-public information and analyses relating to the Resource Provider; (iii) the information submitted by the Resource Provider to the WRM SYSTEM; (iv) the proprietary information and analyses developed on the Resource Provider by the WRM SYSTEM professional staff and/or licensed from third parties; (v) Resource User and general market demand for the Resource Provider's products and services; and (vi) other factors, including market change. For example, only a portion of the Resource Provider Evaluation Criteria will apply to certain Resource Provider Categories, and small-firm Resource Providers in a given Resource Provider Category may be evaluated with respect to only a portion of the Resource Provider Evaluation Criteria applicable to its Resource Provider Category. The information and analyses within each Resource Provider Category (including for some or all of the Resource Providers within the Resource Provider Category) will be regularly updated in whole or in part, and this updating process is an essential element of this invention.

C.1.c. Categories of Resource User Information and Analyses: The categories of Resource User information and analyses will vary for each industry-specific application of this invention, and may be revised from time to time. With respect to the financial services industry application, as an exemplary embodiment of this invention, the categories of Resource User information and analyses may contain some or all of the categories listed below, and may contain additional and/or revised categories as revised from time to time (said categories of Resource User information and analyses are hereinafter sometimes collectively referred to as the “Resource User Info Categories”.

Resource User Info Categories: Resource User Profiles, Resource User Practices, Resource User Activity Trends, Resource User Need Trends, Resource User Reviews of Resource Providers, Resource User Feedback.

The nature and extent of the information and analyses within each Resource User Info Category will vary, depending upon (i) the availability of public and non-public information and analyses relating to the Resource User Category; (ii) the information submitted by Resource Users to the WRM SYSTEM; (iii) the proprietary information and analyses developed on the Resource User Info Category by the WRM SYSTEM professional staff and/or licensed from third parties; (iv) Resource Provider, Resource User, and general market demand for the information and analyses contained in the Resource User Category; and (v) other factors, including market change. The information and analyses within each Resource User Category will be regularly updated in whole or in part, and this updating process is an essential element of this invention.

C.1.d. Categories of Industry-Related and Market-Related Information and Analyses: The categories of industry-related and market-related information and analyses will vary for each industry-specific application of this invention, and may be revised from time to time. With respect to the financial services industry application, as an exemplary embodiment of this invention, the categories of industry-related and market-related information and analyses may contain some or all of the categories listed below, and may contain additional and/or revised categories as revised from time to time (said categories of industry-related and market-related information and analyses are hereinafter sometimes collectively referred to as the “Industry Info Categories”).

Industry Info Categories: Resource Provider Market Trends, Resource Provider Best Practices, Resource User Market Trends, Industry Sector Trends, Industry Regulatory Trends, Resource User Education.

The nature and extent of the information and analyses within each Industry Info Category will vary, depending upon (i) the availability of public and non-public information and analyses relating to the Industry Info Category; (ii) the information submitted by Resource Providers and Resource Users to the WRM SYSTEM; (iii) the proprietary information and analyses developed on the Industry Info Category by the WRM SYSTEM professional staff and/or licensed from third parties; (iv) Resource User, Resource Provider, and general market demand for the information and analyses contained in the Industry Info Category; and (v) other factors, including market change. The information and analyses within each Industry Info Category will be regularly updated in whole or in part, and this updating process is an essential element of this invention.

C.2. DATA CONTENT SOURCES: The WRM SYSTEM data content sources will consist of several types of sources which may vary for each industry-specific application of this invention and which may be revised from time to time (said data content sources are hereinafter sometimes collectively referred to as the “Data Content Sources”). The quality and integrity of each Data Content Source will be evaluated and approved by WRM SYSTEM professional staff before data content from said source is input into the WRM SYSTEM, to the extent necessary to insure quality control standards and to the extent practical and feasible. Data Content Sources may vary for each Resource Provider Category, and may be revised from time to time for a given Resource Provider Category. With respect to the financial services industry application, as an exemplary embodiment of this invention, Data Content Sources may contain some or all of the types of sources listed below, and may contain additional or revised types of sources as revised from time to time.

Types of Data Content Sources: (1) Public information, including, without limitation, regulatory and other public filings; company, industry, and news web sites; company literature, press releases, and marketing materials; industry and news publications, blogs, and other media channels; and web-based search engines and RSS feeds. (2) Information and analyses submitted to the WRM SYSTEM by Resource Providers, Resource Users, WRM SYSTEM business partners, and third parties. (3) Information and analyses internally developed from WRM Web Site user and visitor traffic. (4) Proprietary information, analyses, best practices, evaluations, ratings, and rankings internally developed by WRM SYSTEM professional staff and/or by this staff in conjunction with WRM SYSTEM advisory boards and councils, business partners, and/or third parties. (5) Proprietary information, analyses, best practices, evaluations, ratings, and rankings developed by third parties and incorporated into the WRM SYSTEM by purchase, license, subscription, or other contractual arrangement.

C.3. DATA CONTENT COMPILATION AND SYSTEM INPUT: The WRM SYSTEM data content compilation and system input process may vary for each industry-specific application of this invention and may be revised from time to time (said data content compilation and system input process is hereinafter sometimes collectively referred to as the “Data Compilation Process”). With respect to the financial services industry application, as an exemplary embodiment of this invention, the Data Compilation Process will be conducted by WRM SYSTEM professional staff in conjunction with third parties, including, for example and without limitation, WRM SYSTEM business partners and/or independent contractors.

Data Content Compilation Cycles: Data content will be compiled, analyzed, categorized, and input in several data collection cycles. Data collection prioritization may be based upon several factors, including, without limitation, one or more of the following factors: (i) Resource User, Resource Provider, and general market demand for the information and analyses contained in the data content category; (ii) the importance of the data content to WRM SYSTEM users; (iii) the ease of access to the data content; (iv) time required to complete the Data Compilation Process for the data content category; and (v) other relevant factors. For example, with respect to the financial services industry application, as an exemplary embodiment of this invention, data content compilation cycles may consist of one or more of the following cycles: (i) Data Collection Cycle 1: Financial Asset Management Resources—12 (most important) categories, Development Period: Months 1-16; Data Collection Cycle 2: Financial Asset Management Resources—16 (less important) categories, Development Period: Months 16-30; Data Collection Cycle 3: Non-Financial Asset Management Resources and Miscellaneous Resources—8 categories, Development Period: Months 31-36.

The Data Content Structure, the Data Content Sources, and the Data Compilation Process are designed to produce accurate, precise, and comprehensive information and analyses to the extent practical and logistically feasible within the development process time frame. Data content scope, depth, and integrity are vitally important in the proper implementation of product and service resource management.

D. WRM SYSTEM EVALUATION MODELS: The WRM SYSTEM Evaluation Models (hereinafter sometimes collectively referred to as the “Evaluation Models”) will be developed by WRM SYSTEM professional staff in conjunction with third parties, including, for example and without limitation, WRM SYSTEM advisory boards and councils, business partners, and/or independent contractors. The Evaluation Model development process may vary for each industry-specific application of this invention and may be revised from time to time.

The WRM SYSTEM Evaluation Models are designed to combine, analyze, and synthesize a diverse range of WRM SYSTEM Knowledge Base data and analyses pertaining to each Resource Provider Category, and to provide a template and standardized rating system that will produce certain types of evaluations with respect to a given Resource Provider Category and a given Resource Provider. The Evaluation Models may vary for each industry-specific application of this invention, and may be revised from time to time. Also, the Evaluation Models for each Resource Provider Category within an industry-specific application may vary, and may be revised from time to time.

D.1. EVALUATION MODEL STRUCTURAL COMPONENTS: The WRM SYSTEM Evaluation Models will consist of analytical templates containing certain structural components which may vary for each industry-specific application of this invention and may be revised from time to time. These structural components also may vary for each Resource Provider Category, as revised from time to time. These structural components will include, without limitation, one or more of the following components:

WRM Knowledge Base content (including all database content described in Section C above).

Business rules and multi-factor analytical equations, including, without limitation, cause-and-effect equations and econometric modeling.

Proprietary evaluation standards, guidelines, best practices, and reference points developed by WRM SYSTEM professional staff and/or by said professional staff in conjunction with third parties, including, without limitation, the WRM SYSTEM Evaluation Criteria described above in Section C.

Third-party information, analyses, and software, incorporated via license or other contractual arrangements.

D.2. EVALUATION MODEL FUNCTIONS: The Evaluation Models will produce various types of functional results, which may vary for each industry-specific application of this invention and which may be revised from time to time. Functional results also may vary for each Resource Provider Category within an industry-specific application, and may be revised from time to time. Functional results may include, for example and without limitation, one or more of the following results:

Automatic selection of Resource Providers, and Resource Provider products and services, based upon user-based, user-specified, and/or other customized parameters and criteria.

Automatic qualitative rating and ranking of Resource Providers within a Resource Provider Category, based upon user-based, user-specified, and/or other customized parameters and criteria.

Automatic quantitative rating and ranking of Resource Providers within a Resource Provider Category, based upon user-based, user-specified, and/or other customized parameters and criteria.

Various types of Resource Provider competitive analyses.

Various types of forecasting analyses relating to Resource Providers, Resource Users, industry or market trends, or other areas relevant to resource management within the specific industry.

Closing Remarks:

The Diagrams appended hereto are intended to provide a simple illustration of only a portion of the functions, components, attributes, and processes of this invention, and do not illustrate many of the functions, components, attributes, and processes of this invention described in this detailed description. Accordingly, said Diagrams are not intended to limit or define this invention, or otherwise to limit the scope or purposes of this invention in any way.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all of the Claims. As used herein, the terms “consists of,” “contains,” “comprised of”, “comprises”, or any related terms and/or other variations thereof, are intended to cover a non-exclusive inclusion, such that a process, method, functional component, or other system component that comprises a list of elements does not include only those elements but may include other elements not expressly listed or inherent to such process, method, functional component, or other system component. Further, no element described herein is required for the practice of this invention unless expressly described herein as “essential” or “critical”.

In summary, this invention provides a disciplined approach to industry-specific resource sourcing, evaluation, selection, and management (sometimes collectively referred to herein as “resource management”), utilizing an organized method and system that provides sufficient resource information and independent resource evaluation so that the individual or business resource user can make informed, intelligent, efficient, timely decisions in his resource management at his convenience and at a low or minimal cost. Because this invention's application is intended to be customized for industry-specific needs, this invention is able to address the user's customized resource management needs and provide him with the specialized and unbiased information necessary for the user to make the right resource choices for the user's particular needs as they may change from time to time. At the same time, this invention also allows for standardization of resource evaluation across the general user community in specific industries, by providing resource evaluations based upon industry-specific standardized criteria.

In summary, this invention effectively addresses the costly, time-consuming, difficult, and complex process of product and service resource management in our modern age for both the individual and business consumer, and provides a convenient, economical, practical, and effective business solution to this problem.

The foregoing detailed description of this invention has been presented for purposes of illustration and description. It is not intended to be exhaustive or to limit this invention to the precise forms disclosed. Many modifications and variations are possible in light of the above teaching. The embodiments of this invention described herein were chosen in order to best explain the principles of this invention and its practical application, to thereby enable others skilled in the art to best utilize this invention in various embodiments and with various modifications as are suited to the particular use contemplated. It is intended that the scope of this invention be defined by the Claims appended hereto, which themselves recite those features regarded as essential to this invention.

What is claimed is:

1. A web-based and/or computer-implemented system and method, with industry-specific system and method templates, for standardizing, automating, and facilitating, in whole or in part, at least one of the identification, evaluation, selection, management, and administration of product and service resources; and said system and method to comprise both functional technology components and database components; and (A) said functional technology components to include at least one of the (i) web search and querying and/or database search and querying capabilities; (ii) software components that combine business rules and/or analytic equations and/or industry-specific or user-based criteria, standards, best practices, or other relevant parameters or guidelines, that, when applied to the database, generate a result or action that relates to at least one of the identification, evaluation, selection, management, and/or administration of product and service resources; and (iii) email, telecommunication, data transmission, audio and video transmission, transaction-based, security, networking, and other conventional software and/or hardware; and (B) said database components to include at least one of the (i) information and analyses on product and service resources within a specific industry; (ii) information and analyses on resource users within a specific industry; (iii) information and analyses on customer markets within a specific industry; (iv) information and analyses on trends, business practices, and/or market practices within a specific industry; (v) resource provider and resource user feedback within a specific industry; (vi) qualitative and/or quantitative resource evaluation standards and/or models for the specific industry; and (vii) proprietary analyses of the foregoing database information, analyses, standards, and models, in whole or in part.

2. A web-based and/or computer-implemented system and method, with industry-specific system and method templates, for providing and facilitating, in whole or in part, at least one of the consulting, advisory, product development, advertising, marketing, sales, distribution, customer servicing, customer management, and similar services for product and service resource providers within a specific industry; and said system and method to comprise both functional technology components and database components; and (A) said functional technology components to include at least one of the (i) web search and querying and/or database search and querying capabilities; (ii) software components that combine business rules and/or analytic equations and/or industry-specific or user-based criteria, standards, best practices, or other relevant parameters or guidelines, that, when applied to the database, generate a result or action that relates to at least one of the identification, evaluation, selection, management, and/or administration of product and service resources; and (iii) email, telecommunication, data transmission, audio and video transmission, transaction-based, security, networking, and other conventional software and/or hardware; and (B) said database components to include at least one of the (i) information and analyses on product and service resources within a specific industry; (ii) information and analyses on resource users within a specific industry; (iii) information and analyses on customer markets within a specific industry; (iv) information and analyses on trends, business practices, and/or market practices within a specific industry; (v) resource provider and resource user feedback within a specific industry; (vi) qualitative and/or quantitative resource evaluation standards and/or models for the specific industry; and (vii) proprietary analyses of the foregoing database information, analyses, standards, and models, in whole or in part.

3. A web-based and/or computer-implemented system and method, with industry-specific system and method templates, for facilitating, in whole or in part, at least one of the interactive communications, collaborative activities, and transactional activities between and among users and providers of product and service resources within a specific industry, and said interactive communications, collaborative activities, and transactional activities to include at least one of the (i) email communications, instant messaging, VoIP, audio/video communications, and/or other telecommunications capabilities (including, without limitation, wireless technologies such as Bluetooth and Wi-Fi); (ii) educational, business networking, social, and/or cultural event activities; (iii) purchase and fulfillment of product and service resources; (iv) live auctions of product and/or service resources; (v) customer servicing and customer management; and (vi) contractual arrangements between and among resource users and resource providers; and said system and method to comprise both functional technology components and database components; and (A) said functional technology components to include at least one of the (i) web search and querying and/or database search and querying capabilities; (ii) software components that combine business rules and/or analytic equations and/or industry-specific or user-based criteria, standards, best practices, or other relevant parameters or guidelines, that, when applied to the database, generate a result or action that relates to at least one of the identification, evaluation, selection, management, and/or administration of product and service resources; and (iii) email, telecommunication, data transmission, audio and video transmission, transaction-based, security, networking, and other conventional software and/or hardware; and (B) said database components to include at least one of the (i) information and analyses on product and service resources within a specific industry; (ii) information and analyses on resource users within a specific industry; (iii) information and analyses on customer markets within a specific industry; (iv) information and analyses on trends, business practices, and/or market practices within a specific industry; (v) resource provider and resource user feedback within a specific industry; (vi) qualitative and/or quantitative resource evaluation standards and/or models for the specific industry; and (vii) proprietary analyses of the foregoing database information, analyses, standards, and models, in whole or in part.
